(19) United States
(12) Patent Application Publication
(10) Pub. No.: US 2025/0392153 A1
(43) Pub. Date: Dec. 25, 2025

(54) ACTIVE DISCHARGER FOR HIGH VOLTAGE CAPACITORS WITH REDUCED IDLE POWER LOSS

(71) Applicant: Apple Inc., Cupertino, CA (US)

(72) Inventors: Chanwit Prasantanakorn, Santa Clara, CA (US); Bharat K Patel, San Martin, CA (US)

(21) Appl. No.: 18/749,972

(22) Filed: Jun. 21, 2024

(51) Int. Cl. H02J 7/34; H02J 7/00; H02J 7/06

(52) U.S. Cl. CPC H02J 7/345; H02J 7/00304; H02J 7/06; H02J 2207/20; H02J 2207/50

(57) ABSTRACT

An active capacitor discharging circuit for a power supply can include a current source adapted to be coupled between one or more capacitors and ground; and a voltage-controlled switch that selectively opens responsive to the power supply operating to reduce power consumed by the current source and selectively closes responsive to the power supply not-operating to allow the current source to discharge the one or more capacitors. The current source can include a depletion mode MOSFET coupled to a source resistance such that a channel of the depletion mode MOSFET is in series with the source resistance and a distal terminal of the source resistance is coupled to a gate of the depletion mode MOSFET. The voltage-controlled switch can include a P-channel JFET in series with the current source.

### BACKGROUND

Switching power supplies are used in a wide variety of applications. In some applications, such switching power supplies may include relatively large capacitors, such as DC bulk capacitors, EMI filtering capacitors, and the like. Such capacitors can store charge and therefore energy when the device is de-powered. In some applications, it may be desirable to provide mechanisms for discharging such capacitors when the device is turned off

### SUMMARY

An active capacitor discharging circuit for a power supply can include a current source adapted to be coupled between one or more capacitors and ground, wherein the current source comprises a depletion mode MOSFET coupled to a source resistance such that a channel of the depletion mode MOSFET is in series with the source resistance and a distal terminal of the source resistance is coupled to a gate of the depletion mode MOSFET; a voltage-controlled switch that selectively opens responsive to the power supply operating to reduce power consumed by the current source and selectively closes responsive to the power supply not-operating to allow the current source to discharge the one or more capacitors, wherein the voltage-controlled switch comprises a P-channel JFET in series with the current source; and a current limiting component in series with the current source.

An active capacitor discharging circuit that discharges the bulk capacitor when the power supply is de-energized. The active capacitor discharging circuit can further include a current source adapted to be coupled between one or more capacitors and ground; and a voltage-controlled switch that selectively opens responsive to the power supply operating to reduce power consumed by the current source and selectively closes responsive to the power supply not-operating to allow the current source to discharge the one or more capacitors. The current source can include a depletion mode MOSFET coupled to a source resistance such that a channel of the depletion mode MOSFET is in series with the source resistance and a distal terminal of the source resistance is coupled to a gate of the depletion mode MOSFET. The voltage-controlled switch can include a P-channel JFET in series with the current source. The P-channel JFET can be disposed between the depletion mode MOSFET and the source resistance such that the distal terminal of the source resistance is coupled to ground, thereby allowing a voltage across the source resistance to be used to monitor a discharging current. The power supply can further include a current limiting component in series between the bulk capacitor and the current source. The power supply can further include an EMI filter coupled between the input and the rectifier and an X-capacitor coupled across the AC input; and first and second diodes coupling the X-capacitor to the active capacitor discharging circuit such that the active capacitor discharging circuit can also discharge the X-capacitor when the power supply is de-energized. The power supply can further include a current limiting component in series between the X-capacitor and the current source.

An active capacitor discharging circuit for a power supply can include a current source adapted to be coupled between one or more capacitors and ground; and a voltage-controlled switch that selectively opens responsive to the power supply operating to reduce power consumed by the current source and selectively closes responsive to the power supply not-operating to allow the current source to discharge the one or more capacitors. The current source can include a depletion mode MOSFET coupled to a source resistance such that a channel of the depletion mode MOSFET is in series with the source resistance and a distal terminal of the source resistance is coupled to a gate of the depletion mode MOSFET. The voltage-controlled switch can include a P-channel JFET in series with the current source. The P-channel JFET can be disposed between the depletion mode MOSFET and the source resistance such that the distal terminal of the source resistance is coupled to ground, thereby allowing a voltage across the source resistance to be used to monitor a discharging current. The active capacitor discharging circuit can further include a current limiting component in series with the current source. The current liming component can be selected from the group consisting of: a fuse, a fusible link, a current limiting resistor, and a positive temperature coefficient thermistor.

### BRIEF DESCRIPTION OF THE DRAWINGS

FIGS. 1A and 1B illustrate schematic diagrams AC-DC power supplies.

FIG. 2 illustrates an active capacitor discharge circuit.

FIG. 3 illustrates characteristics of enhancement mode versus depletion mode MOSFETs.

FIG. 4 illustrates a transfer characteristic of an example depletion mode MOSFET used in an active capacitor discharge circuit.

FIG. 5 illustrates a current source implemented using a depletion mode MOSFET.

FIG. 6 illustrates an active capacitor discharge circuit using a current source as in FIG. 5.

FIG. 7 illustrates various aspects of a P-channel JFET.

FIG. 8 illustrates characteristics of P-channel JFETs.

FIG. 9 illustrates an active capacitor discharge circuits using a P-channel JFET.

FIGS. 10A and 10B illustrate alternative configurations of active capacitor discharge circuits using a current source as in FIG. 5 and a P-channel JFET as in FIG. 9.

FIGS. 11a and 11B illustrate schematic diagrams of AC-DC power supplies including x-capacitors for EMI filtering and active capacitor discharge circuits as in FIGS. 10A-10B.

### DETAILED DESCRIPTION

In the following description, for purposes of explanation, numerous specific details are set forth to provide a thorough understanding of the disclosed concepts. As part of this description, some of this disclosure's drawings represent structures and devices in block diagram form for sake of simplicity. In the interest of clarity, not all features of an actual implementation are described in this disclosure. Moreover, the language used in this disclosure has been selected for readability and instructional purposes, has not been selected to delineate or circumscribe the disclosed subject matter. Rather the appended claims are intended for such purpose.

Various embodiments of the disclosed concepts are illustrated by way of example and not by way of limitation in the accompanying drawings in which like references indicate similar elements. For simplicity and clarity of illustration, where appropriate, reference numerals have been repeated among the different figures to indicate corresponding or analogous elements. In addition, numerous specific details are set forth to provide a thorough understanding of the implementations described herein. In other instances, methods, procedures, and components have not been described in detail so as not to obscure the related relevant function being described. References to “an,” “one,” or “another” embodiment in this disclosure are not necessarily to the same or different embodiment, and they mean at least one. A given figure may be used to illustrate the features of more than one embodiment, or more than one species of the disclosure, and not all elements in the figure may be required for a given embodiment or species. A reference number, when provided in a given drawing, refers to the same element throughout the several drawings, though it may not be repeated in every drawing. The drawings are not to scale unless otherwise indicated, and the proportions of certain parts may be exaggerated to better illustrate details and features of the present disclosure.

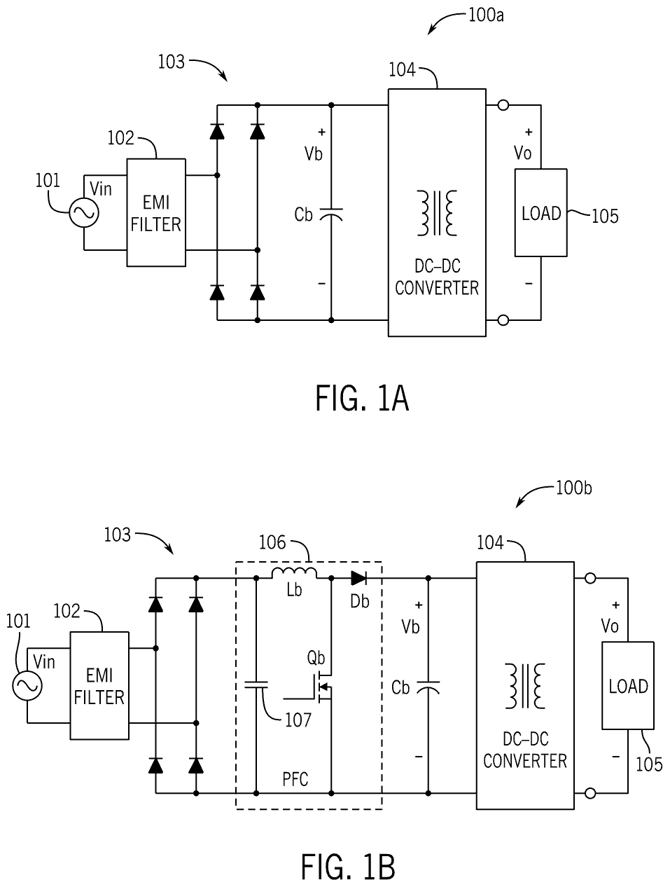

Electrical devices or equipment may include an AC-DC power supply unit (PSU) to power its internal circuitry from AC mains voltage. Exemplary AC-DC PSUs 100a and 100b are depicted in FIGS. 1A and 1B. The PSU can receive AC mains voltage 101, which can be passed through an electromagnetic interference filtering circuit 102. The EMI filtered voltage can then be provided to a rectifier 103 which can produce a DC voltage Vb applied across bulk capacitor (Cb). Rectifiers convert a sinusoidal AC voltage to a pulsating DC voltage. Then, the bulk capacitors Cb, able to store electrical charge, act as a filter to convert a pulsating DC voltage into a smooth DC voltage suitable for the downstream circuits. Such downstream circuits may include a DC-DC converter 104, which can convert the smoothed DC voltage into a different voltage and/or current to meet the requirements of a load 105. DC-DC converter 104 can receive the input voltage Vb and produce an output voltage Vo. The DC-DC converter may be of any of a variety of topologies, such as a flyback converter, a buck converter, a boost converter, a buck-boost converter, an LLC converter, etc.

Some PSUs (e.g., PSUs with power ratings above about 75 W) may also include a power factor correction circuit (PFC) 106 to shape the input current waveform and achieve a higher power factor. PFC circuit 106 can be connected between the rectifier 103 and bulk capacitor Cb. The bulk capacitor Cb can retain a high voltage for a significant period of time after removal of AC mains voltage 101 if there is no path for the stored charge to discharge. Therefore, having a discharge mechanism for the bulk capacitor may desirable. A simple bleed resistor parallel with bulk capacitor Cb can work as a discharger but may not be an optimal solution because it constantly dissipates power during normal operation. To avoid this continual energy consumption, a discharger circuit can have an active switch to disconnect the discharge element from the circuit when the PSU is active.

Described below are active discharge circuits for high voltage charged capacitors that consume very little bias power. The circuits can include a current source and a controlled switch that can be activated by the condition of the power supply and/or power supply controller. When the power supply is turned off, the current source can linearly discharge the high-voltage bulk capacitor (or other capacitors) to a low (near-zero) voltage to avoid exposing those opening the device to high voltages.

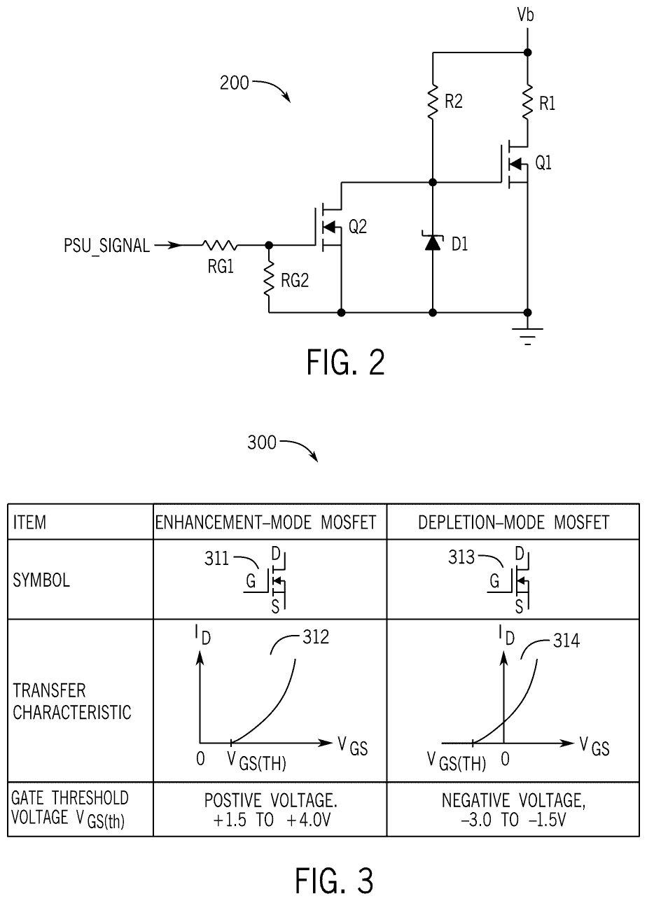

FIG. 2 illustrates an active capacitor discharge circuit 200. The active capacitor discharge circuit 200 can be coupled to the bulk capacitor voltage Vb. PSU_signal can indicate whether the power supply is active or not, and can be indicated, for example, by the PSU controller supply voltage (Vcc), the presence of an AC input (AC_OK), or other suitable signal. The bias circuit for switching device Q1 (illustrated as an enhancement mode MOSFET) can include resistor R2, and a Zener diode D1. Switching device Q2 (also an enhancement mode MOSFET) can turn switching device Q1 on or off, based on PSU_signal, i.e., in response to whether the power supply is active or not. Resistors RG1 and RG2 can scale down the PSU status signal to correspond to the gate voltage rating of Q2. When the PSU is active, PSU_signal is high, which causes switching device Q2 to turn on. This pulls the gate of switching device Q1 to ground, which turns off Q1. The bulk capacitor voltage Vb causes current to flow through resistor R2 and Zener diode Q2 to ground, which incurs some power loss. When the PSU is inactive, e.g., after AC power removal, PSU_signal goes down. Switching device Q2 detects the low voltage of PSU_signal and turns off. This allows the gate of switching device Q1 to rise to the reverse biased Zener diode voltage, turning on Q1 and allowing energy stored in the bulk capacitor (corresponding to voltage Vb) to discharge to ground through resistor R1. Once the energy stored in the capacitor is sufficiently dissipated, switching device Q1 will turn off, disconnecting the discharge element R1 from the circuit.

As briefly mentioned above, resistor R2 in the bias circuit for Q1 always dissipates the power. As a result, such circuits may incur power loss (e.g., on the order of 8-10 mW) when the PSU is in the active state. The discharge time with such circuits may also be quite long because the discharge current decays exponentially with the bulk voltage, Vb. Thus, alternative active capacitor discharge current circuit designs may be preferable. Described below are alternative active capacitor discharger circuits that (1) substantially reduce circuit bias power, (2) provide a constant discharge current allowing for a shorter discharge time, and (3) can be implemented with fewer circuit components.

As described above, use of enhancement-mode MOSFETs in active capacitor discharger circuit 200 requires a positive gate-source voltage (V_{GS}) to turn on and a zero V_{GS} to turn off. In the illustrated circuit, bias power for switching device Q1 will always dissipate through resistor R2 and Zener diode D1 when switching device Q1 is on and through resistor R2 and switching device Q2 when switching device Q1 is off. The power dissipation in the resistor R2 path always exists and is the most significant power loss for such a circuit. However, a depletion mode MOSFET can conduct a current denoted as I_{DSS} at zero V_{GS}. Therefore, a depletion mode MOSFET can be used as a self-powered discharger with a discharge current equal to I_{DSS}. As described in greater detail below, if the discharge current is too high, it can be adjusted by applying a negative V_{GS}. A source resistor R_{S} can be added to generate a negative Vos to adjust the discharge current. Further decreasing the V_{GS} will completely turn off the MOSFET.

FIG. 3 shows a table 300 illustrating the differences between an enhancement mode MOSFET and a depletion mode MOSFET. As indicated by the first row, the circuit symbol 311 for an enhancement mode MOSFET differs from the circuit symbol 313 for a depletion mode MOSFET. More specifically, the segmented drain to source channel for an enhancement mode MOSFET indicates that application of a positive gate to source voltage is necessary to establish conduction from drain to source. Conversely, the solid drain to source channel for a depletion mode MOSFET indicates that the device is conducting by default, unless a negative gate to source voltage is applied. The second row of table 300 depicts exemplary transfer characteristics, namely drain or drain to source current Ip versus gate to source voltage V_{GS}. Transfer curve 312 depicts transfer characteristics of an enhancement mode MOSFET, which, as described above, requires a positive gate to source voltage exceeding a threshold V_{GS}(th) to establish conduction. Conversely, transfer curve 314 depicts transfer characteristics of a depletion mode MOSFET, which conducts unless a negative gate to source voltage exceeding a threshold V_{GS}(th) is applied. The third row of the table illustrates example threshold voltage ranges for each type of switch.

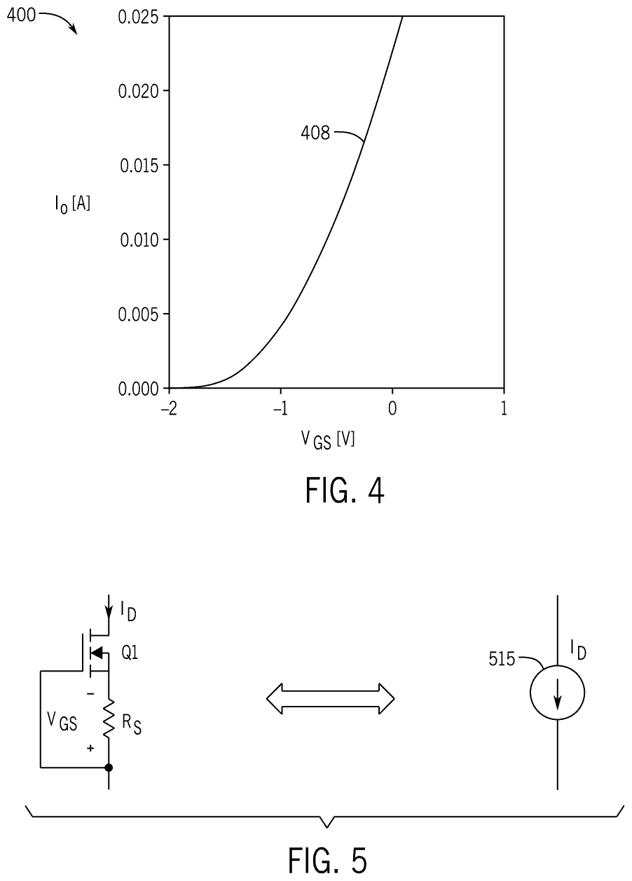

FIG. 4 illustrates a transfer characteristic 400 of an example depletion mode MOSFET (BSS126) that can be used in an active capacitor discharge circuit. The BSS126 is a 600V rated depletion mode MOSFET in an SOT23 package, which may be a suitable part for some bulk capacitor discharger circuits. A value of a resistor R_{S} in series with the source that will produce a desired discharge current can be found using the device transfer characteristic or by the following equations:

$${R}_{S} = \frac{\vert {V}_{G S} \vert}{{I}_{D}}$$

where Rs is the resistance value, V_{GS} is the gate to source voltage, and I_{D} is given by:

$${I}_{D} = {I}_{D S S} \cdot {( 1 - \frac{{V}_{G S}}{{V}_{GS ( th )}} )}^{2}$$

where V_{GS} is the gate to source voltage, V_{GS(th)} is the threshold voltage, and I_{DSS} is the self-powered discharge current described above.

FIG. 5 illustrates a current source 515 implemented using a depletion mode MOSFET, as described above. More specifically, depletion mode MOSFET Q1 will produce a constant discharge current I_{D}. This discharge current flows through resistor R_{S}, which produces the (negative) voltage V_{GS}. Thus, a current source 515 has been created with a depletion mode MOSFET Q1, and a source resistor R_{S} that can self-discharge the capacitor(s) in a PSU (as further described herein). When the PSU is active, a voltage-controlled switch can be used to turn off this current source, example implementations of which are described in greater detail below.

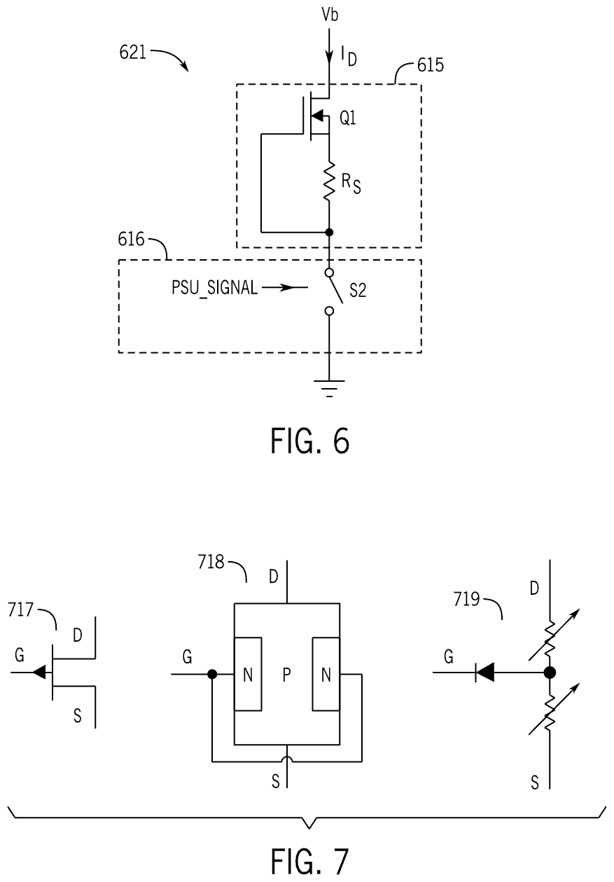

FIG. 6 illustrates an active capacitor discharge circuit 621 using a current source 615 as in FIG. 5. Active capacitor discharge circuit 621 also includes a voltage-controlled switch 616 (also S2) that is responsive to a PSU_signal to selectively open, preventing current flow through the current source 615 and reducing power draw, or selectively close, allowing current flow through current source 615 to discharge the bulk capacitor. Voltage-controlled switch 616 can self-conduct the current (i.e., turn on) when the PSU is inactive and turn off with a positive control voltage when the PSU is active. In some applications, voltage-controlled switch 616 could be a relay with normally closed contacts. In other applications, voltage-controlled switch 616 could be implemented with a P-channel JFET or P-JFET. In still other applications, other forms of normally closed switching device could be used.

FIG. 7 illustrates various aspects of a P-channel JFET. Specifically, P-JFET circuit symbol 717 is a representation of physical construction 718, which shows a P-type channel between drain (D) and source(S) with an N-type gate (G) on either side. When no voltage is applied across the P-N junction (i.e., from gate to source or gate to drain), the P-channel provides an uninterrupted path for the current flowing through. When a positive voltage is applied to reverse bias the P-N junction, the P-channel narrows by increasing the depletion layer, which can put the JFET in the cut-off or pinch-off region. The gate voltage thus controls the drain source or channel resistance, as represented by equivalent circuit schematic 719, which depicts controllable resistances between gate (G) and drain (D) and between gate (G) and source S.

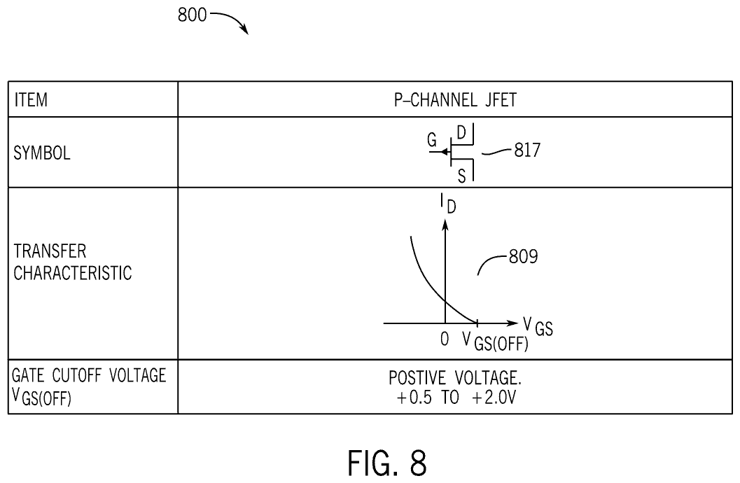

FIG. 8 includes a table 800 depicting characteristics of P-channel JFETs. In the first row, the circuit symbol 817 for a P-channel JFET is depicted. The second row of table 800 depicts exemplary transfer characteristics for a P-JFET, namely drain or drain to source current Ip versus gate to source voltage V_{GS}. More specifically, transfer curve 809 depicts transfer characteristics illustrating how the P-JFET conducts unless a negative gate to source voltage exceeding a threshold V_{GS}(th) is applied. The third row of the table illustrates example threshold voltage ranges for a P-JFET.

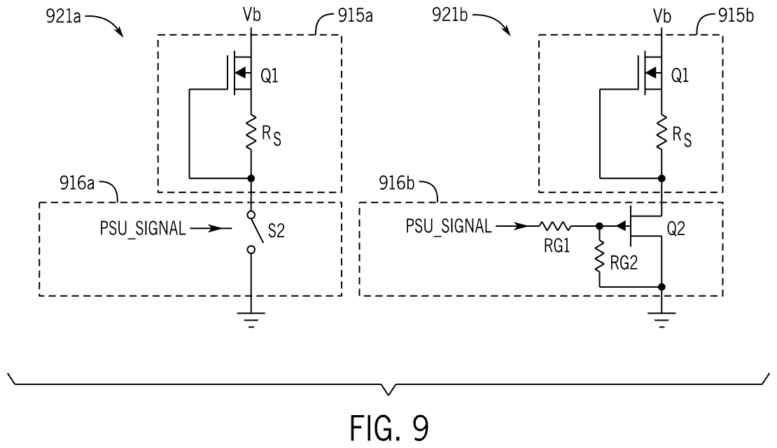

FIG. 9 illustrates an active capacitor discharge circuit using a P-channel JFET. Active capacitor discharge circuit 921a corresponds to active capacitor discharge circuit 621, discussed above with reference to FIG. 6 and incorporates current source 915a, implemented using a depletion mode MOSFET switching device Q1 and source resistor R_{S} as described above, and voltage-controlled switch 916b. Active capacitor discharge circuit 921b corresponds to active capacitor discharge circuit 921b with voltage-controlled switch 916b being implemented using a P-channel JFET switching device Q2. Compared to the active capacitor discharge circuit 200 discussed above with reference to FIG. 2, the circuit(s) of FIG. 9 has fewer overall components and also eliminates the fixed power loss in the resistor R2/Zener diode D1 current path.

Additionally, the drain voltage of P-JFET switching device Q2 can be clamped to the gate voltage via the P-N junction between the gate and drain terminals. Thus, a low-voltage P-JFET device can be used. Resistor RG2 can ensure that switching device Q2's gate voltage reaches zero, so the P-JFET can conduct the current when the PSU is inactive. Resistors RG1 and RG2 can scale down the PSU status signal to meet switching device Q2's gate voltage rating.

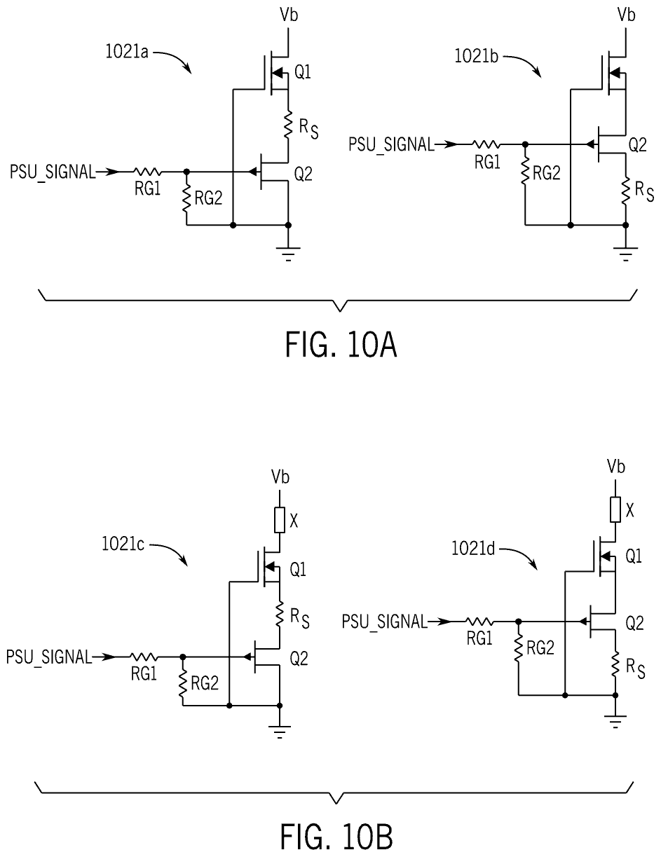

FIGS. 10A and 10B illustrate alternative configurations of active capacitor discharge circuits using a current source implemented with a depletion mode MOSFET as in FIG. 5 and a voltage-controlled switch implemented with a P-channel JFET as in FIG. 9. More specifically, active capacitor discharging circuit 1021a corresponds to active capacitor discharge circuit 921b discussed above. Active capacitor discharging circuit 1021b illustrates a similar circuit with the source resistor R_{S} moved to the other side of P-channel JFET switching device Q2. This can allow for easier use of resistor R_{S} to monitor the discharging current. That is, with one terminal of resistor R_{S} coupled to ground, the voltage thereacross is directly proportional to the discharging current. In active capacitor discharging circuit 1021a, the differential voltage across R_{S} can serve the same function, but monitoring the voltage may be complicated by the need to use a differential voltage rather than an absolute voltage as is possible in active capacitor discharging circuit 1021b.

Active capacitor discharge circuit 1021c corresponds to active capacitor discharging circuit 1021a with the addition of current limiting component X in series between the bulk capacitor and the constant current source formed from depletion mode MOSFET switching device Q1 and source resistance R_{S}. Current limiting component X can be implemented with various devices, such as a fuse, fusible link, current limiting resistor, positive temperature coefficient (PTC) thermistor, etc. The purpose of such device is to limit the current should a short circuit appear on the discharge current path, e.g., across source resistance R_{S}. Similarly, active capacitor discharge circuit 1021d corresponds to active capacitor discharge circuit 1021b with a similar current limiting component X is provided in series for short circuit fault protection.

As noted above, active capacitor discharge circuits 921b and 1021a-1021d can provide for reduced component counts, reducing cost, circuit area, potential failure points, etc. In some applications, the component count may be reduced even further beyond the simplistic seven components (see FIG. 2) versus five components (see FIGS. 9 and 10A-B) in the illustrated schematics. For example, in some applications active capacitor discharging circuit 200 (FIG. 2) may need to have resistors R1 and R2 implemented as series combination resistors to provide the required voltage rating, substantially increasing the component count of such circuits. Conversely, this may not be the case for the same circuit voltages implementing an active capacitor discharging circuit as illustrated in FIGS. 9 and 10A-B.

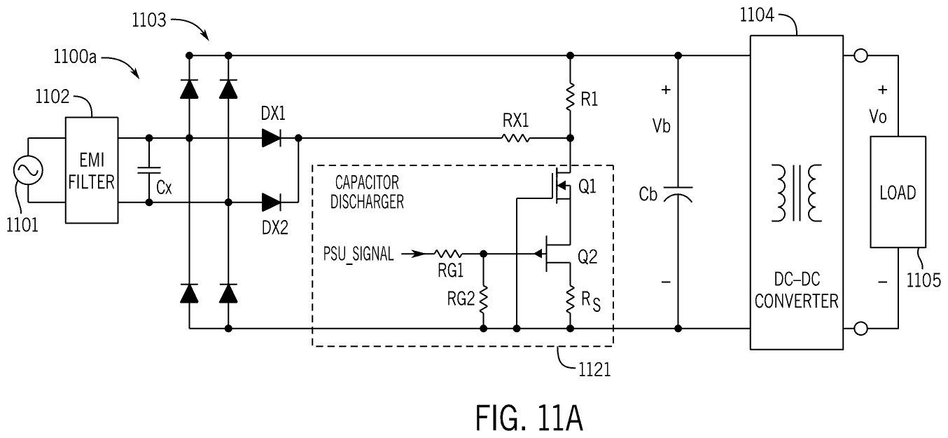

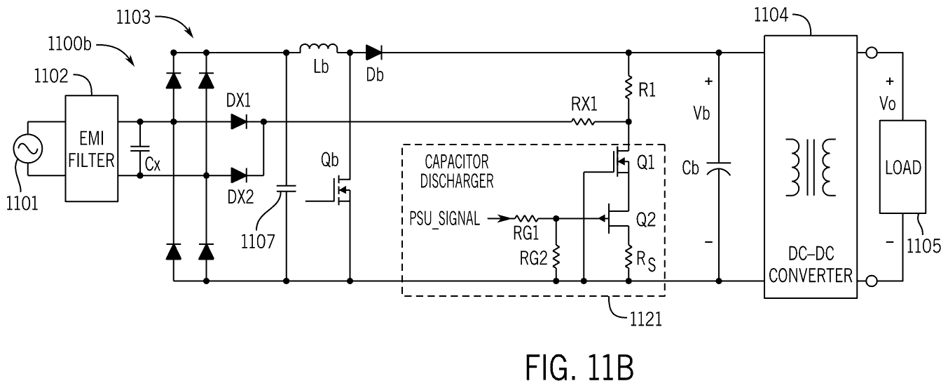

FIGS. 11A and 11B illustrate schematic diagrams of AC-DC power supplies 1100a and 1100b, which are topologically similar to the power supplies discussed above with respect to FIGS. 1A and 1B, respectively, with like reference numbers. Each PSU can receive AC mains voltage 1101, which can be passed through an electromagnetic interference filtering circuit 1102. The EMI filtered voltage can then be provided to a rectifier 1103 which can produce a DC voltage Vb applied across bulk capacitor (Cb). Rectifiers convert a sinusoidal AC voltage to a pulsating DC voltage. Then, the bulk capacitors Cb, able to store electrical charge, act as a filter to convert a pulsating DC voltage into a smooth DC voltage suitable for the downstream circuits. Such downstream circuits may include a DC-DC converter 1104, which can convert the smoothed DC voltage into a different voltage and/or current to meet the requirements of a load 1105. DC-DC converter 1104 can receive the input voltage Vb and produce an output voltage Vo. The DC-DC converter may be of any of a variety of topologies, such as a flyback converter, a buck converter, a boost converter, a buck-boost converter, an LLC converter, etc. Some PSUs (e.g., PSUs with power ratings above about 75 W) may also include a power factor correction circuit (PFC) 1106 to shape the input current waveform and achieve a higher power factor. PFC circuit 1106 can be connected between the rectifier 1103 and bulk capacitor Cb.

Capacitor discharger circuit 1121 can be connected to the system to allow discharge of the bulk capacitor, as has been described above. Resistor R1 is provided for current limiting, although other current limiting components could be used, as described above with reference to FIG. 10B. Additionally, power supplies 1100a and 1100b can include x-capacitors Cx for EMI filtering and active capacitor discharge circuits like those described above with reference to FIGS. 9 and 10A-10B. More specifically, many with an X-capacitor, CX, connected across the AC line. Per IEC 62368-1, the X-capacitor has to be discharged below 60 V within 1 second after AC turn-off. The active capacitor discharge circuits described herein can be used as the X-capacitor discharger as well. Thus, FIGS. 10A and 10B further illustrate an application of such circuits 1121 to PSUs without PFC (FIG. 11A) and PSUs with PFC (FIG. 11B). Diodes DX1 and DX2 provide a discharge path from X-capacitor Cx to the active capacitor discharger circuit 1121. Resistor RX1 can be added to protect the circuit against a single-fault failure. Alternatively, other current limiting components, such as those described above with reference to FIG. 10B could be used. With the active capacitor discharger circuit 1121, bulk capacitor Cb and X-capacitor Cx can be safely discharged to the low voltage after AC turn-off.

The foregoing describes exemplary embodiments of active capacitor discharging circuits. Such configurations may be used in a variety of applications but may be particularly advantageous when used in conjunction with computer power supplies, including but not limited to computers with relatively higher power consumption, such as desktop computers, workstations, servers, and the like. Although numerous specific features and various embodiments have been described, it is to be understood that, unless otherwise noted as being mutually exclusive, the various features and embodiments may be combined various permutations in a particular implementation. Thus, the various embodiments described above are provided by way of illustration only and should not be constructed to limit the scope of the disclosure. Various modifications and changes can be made to the principles and embodiments herein without departing from the scope of the disclosure and without departing from the scope of the claims.

1. An active capacitor discharging circuit for a power supply, the active capacitor discharging circuit comprising:
a current source adapted to be coupled between one or more capacitors and ground, wherein the current source comprises a depletion mode MOSFET coupled to a source resistance such that a channel of the depletion mode MOSFET is in series with the source resistance and a distal terminal of the source resistance is coupled to a gate of the depletion mode MOSFET;
a voltage-controlled switch that selectively opens responsive to the power supply operating to reduce power consumed by the current source and selectively closes responsive to the power supply not-operating to allow the current source to discharge the one or more capacitors, wherein the voltage-controlled switch comprises a P-channel JFET in series with the current source; and
a current limiting component in series with the current source.

2. A power supply comprising:
an input that receives an AC input voltage,
a rectifier and bulk capacitor that cooperate to produce a first DC voltage from the AC input voltage;
a DC-DC converter that converts the first DC voltage to a second DC voltage for delivery to a load; and
an active capacitor discharging circuit that discharges the bulk capacitor when the power supply is de-energized, the active capacitor discharging circuit further comprising:
a current source adapted to be coupled between one or more capacitors and ground; and
a voltage-controlled switch that selectively opens responsive to the power supply operating to reduce power consumed by the current source and selectively closes responsive to the power supply not-operating to allow the current source to discharge the one or more capacitors.

3. The power supply of claim 2 wherein the current source comprises a depletion mode MOSFET coupled to a source resistance such that a channel of the depletion mode MOSFET is in series with the source resistance and a distal terminal of the source resistance is coupled to a gate of the depletion mode MOSFET.

4. The power supply of claim 3 wherein the voltage-controlled switch comprises a P-channel JFET in series with the current source.

5. The power supply of claim 4 wherein the P-channel JFET is disposed between the depletion mode MOSFET and the source resistance such that the distal terminal of the source resistance is coupled to ground, thereby allowing a voltage across the source resistance to be used to monitor a discharging current.

6. The power supply of claim 3 wherein the P-channel JFET is disposed between the depletion mode MOSFET and the source resistance such that the distal terminal of the source resistance is coupled to ground, thereby allowing a voltage across the source resistance to be used to monitor a discharging current.

7. The power supply of claim 2 further comprising a current limiting component in series between the bulk capacitor and the current source.

8. The power supply of claim 2 further comprising:
an EMI filter coupled between the input and the rectifier and an X-capacitor coupled across the AC input; and
first and second diodes coupling the X-capacitor to the active capacitor discharging circuit such that the active capacitor discharging circuit can also discharge the X-capacitor when the power supply is de-energized.

9. The power supply of claim 8 wherein the current source comprises a depletion mode MOSFET coupled to a source resistance such that a channel of the depletion mode MOSFET is in series with the source resistance and a distal terminal of the source resistance is coupled to a gate of the depletion mode MOSFET.

10. The power supply of claim 9 wherein the voltage-controlled switch comprises a P-channel JFET in series with the current source.

11. The power supply of claim 10 wherein the P-channel JFET is disposed between the depletion mode MOSFET and the source resistance such that the distal terminal of the source resistance is coupled to ground, thereby allowing a voltage across the source resistance to be used to monitor a discharging current.

12. The power supply of claim 9 wherein the P-channel JFET is disposed between the depletion mode MOSFET and the source resistance such that the distal terminal of the source resistance is coupled to ground, thereby allowing a voltage across the source resistance to be used to monitor a discharging current.

13. The power supply of claim 8 further comprising a current limiting component in series between the X-capacitor and the current source.

14. An active capacitor discharging circuit for a power supply, the active capacitor discharging circuit comprising:
a current source adapted to be coupled between one or more capacitors and ground; and
a voltage-controlled switch that selectively opens responsive to the power supply operating to reduce power consumed by the current source and selectively closes responsive to the power supply not-operating to allow the current source to discharge the one or more capacitors.

15. The active capacitor discharging circuit of claim 14 wherein the current source comprises a depletion mode MOSFET coupled to a source resistance such that a channel of the depletion mode MOSFET is in series with the source resistance and a distal terminal of the source resistance is coupled to a gate of the depletion mode MOSFET.

16. The active capacitor discharging circuit of claim 15 wherein the voltage-controlled switch comprises a P-channel JFET in series with the current source.

17. The active capacitor discharging circuit of claim 16 wherein the P-channel JFET is disposed between the depletion mode MOSFET and the source resistance such that the distal terminal of the source resistance is coupled to ground, thereby allowing a voltage across the source resistance to be used to monitor a discharging current.

18. The active capacitor discharging circuit of claim 15 wherein the P-channel JFET is disposed between the depletion mode MOSFET and the source resistance such that the distal terminal of the source resistance is coupled to ground, thereby allowing a voltage across the source resistance to be used to monitor a discharging current.

19. The active capacitor discharging circuit of claim 14 further comprising a current limiting component in series with the current source.

20. The active capacitor discharging circuit of claim 19 wherein the current liming component is selected from the group consisting of: a fuse, a fusible link, a current limiting resistor, and a positive temperature coefficient thermistor.
